(19) United States
(12) Patent Application Publication
(10) Pub. No.: US 2002/0000951 A1
(43) Pub. Date: Jan. 3, 2002

(54) Display device enhancements

(76) Inventor: Angus Duncan Richards, Los Angeles, CA (US)

Correspondence Address: Angus Duncan Richards, 5016 Kelly Street, Los Angeles, CA, 90066, US

(21) Appl. No.: 09/892,168

(22) Filed: Jun. 25, 2001

Related U.S. Application Data
(60) Provisional application No. 60/213,891, filed on Jun. 26, 2000.

(51) Int. Cl. G09G 5/00

(52) U.S. Cl. 345/8

(57) ABSTRACT

The present invention relates generally to various arrangements of optical and electronic components to form a high-resolution helmet mounted display (HMD) or other compact display device utilizing one or more reflective mode display devices for the generation of imagery.

### REFERENCE TO RELATED APPLICATION

This application claims priority of U.S. provisional patent 60/213891 titled “Display Device Enhancements” filed Jun. 26, 2000 by Angus Duncan Richards.

### BACKGROUND AND SUMMARY OF THE INVENTION

The present invention relates generally to various arrangements of optical and electronic components to form a high-resolution helmet mounted display (HMD) or other compact display device.

This specification expands upon the concepts outlined in the provisional patent titled “virtual reality display device” (60/214251) and in particular outlines several preferred embodiments of the display device.

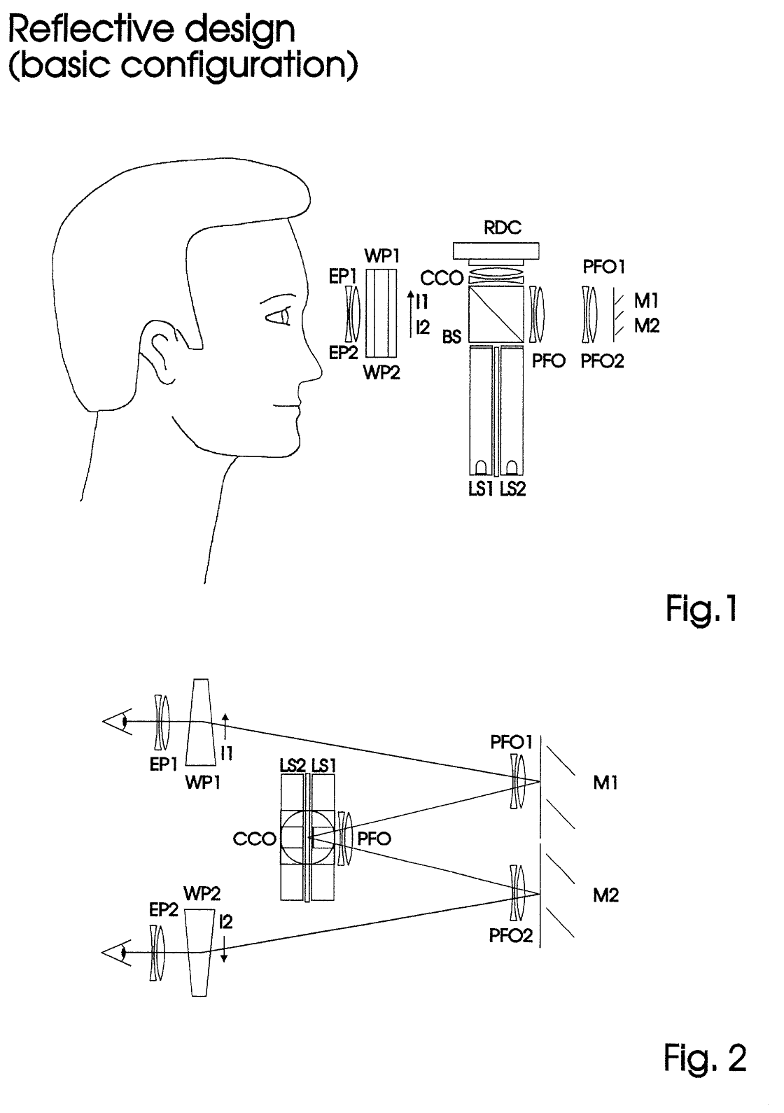

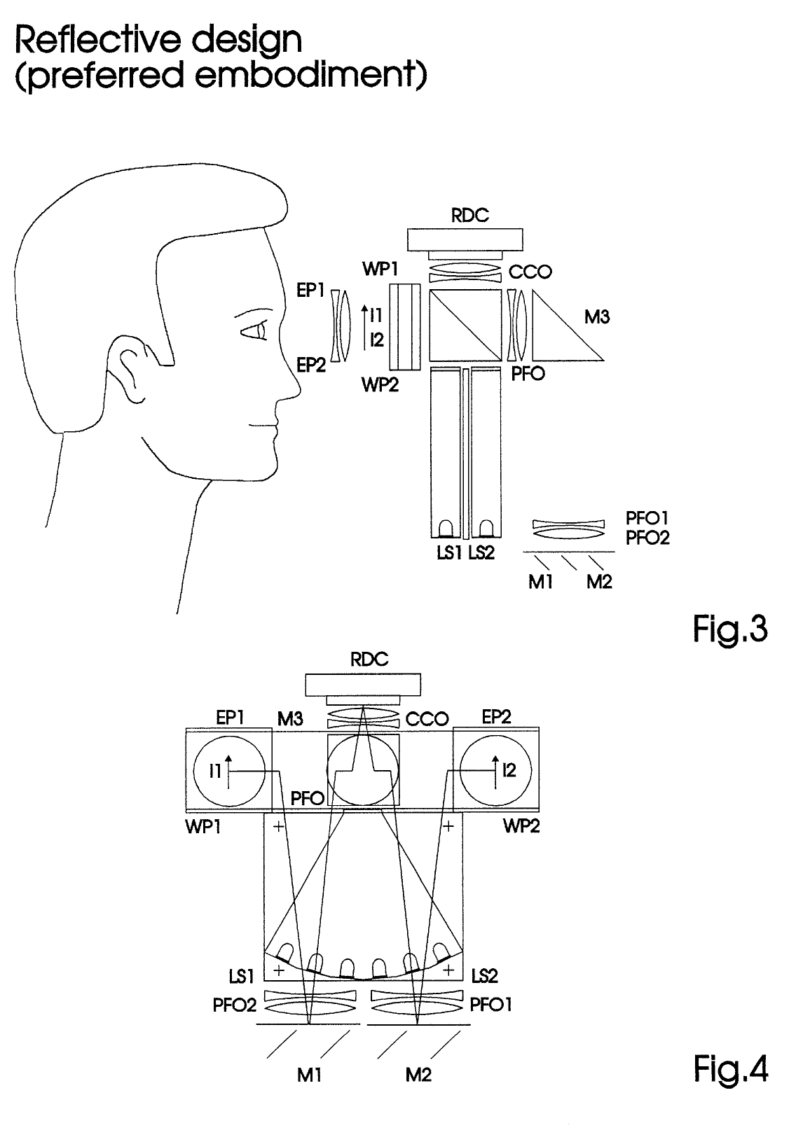

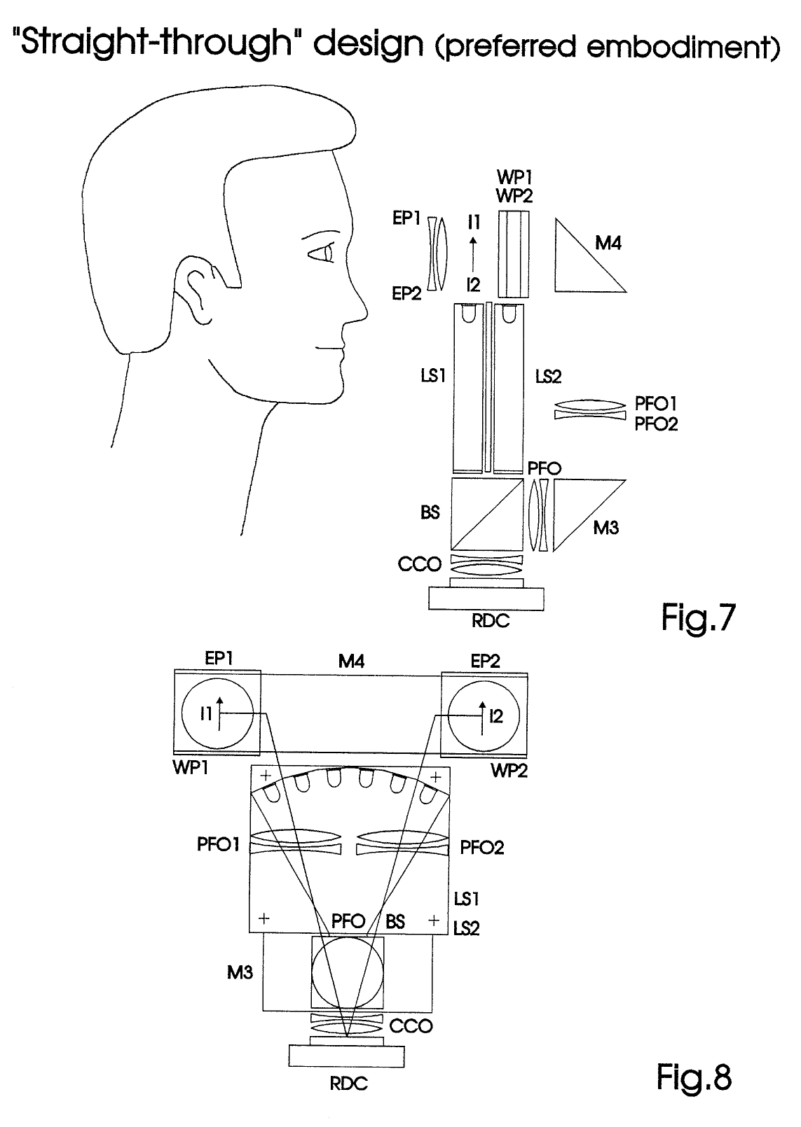

There are two basic configurations for the single chip based HMD. These are titled “straight through” and “reflective” designs and are illustrated in FIGS. 1-2, 5-6. The designs shown in these illustrations have been show as a simple “straight” optical path. In a practical HMD design this optical path would probably be “folded” through the use of a series of prisms or mirrors so as to make the HMD design more compact. There are many variants upon this basic design, several of which are shown in FIGS. 3-4 and FIGS. 7-8 The choice of configuration is affected significantly by the design and space requirements of the HMD thus the technique used to reduce the physical size of the optical arrangement should not be considered an important factor in defining the technology.

### BASIC COMPONENTS

The basic components used in the HMD design are as follows:

1) Reflective display device (Digital Micro-Mirror chip (DMM) or other reflective technology such as Ferro Electric Display (FED))—Reflective Display Chip (RDC)

2) Light sources (LS1, LS2)

3) Beam splitter (BS)

4) Chip collimating optics (CCO)

5) Primary focusing optics (PFO1, PFO2)

6) Eyepieces optics (EP1, EP2)

7) Pre-focusing optics (PFO)

8) Wedge prisms (WP1, WP2)

9) Primary mirrors (M1, M2)

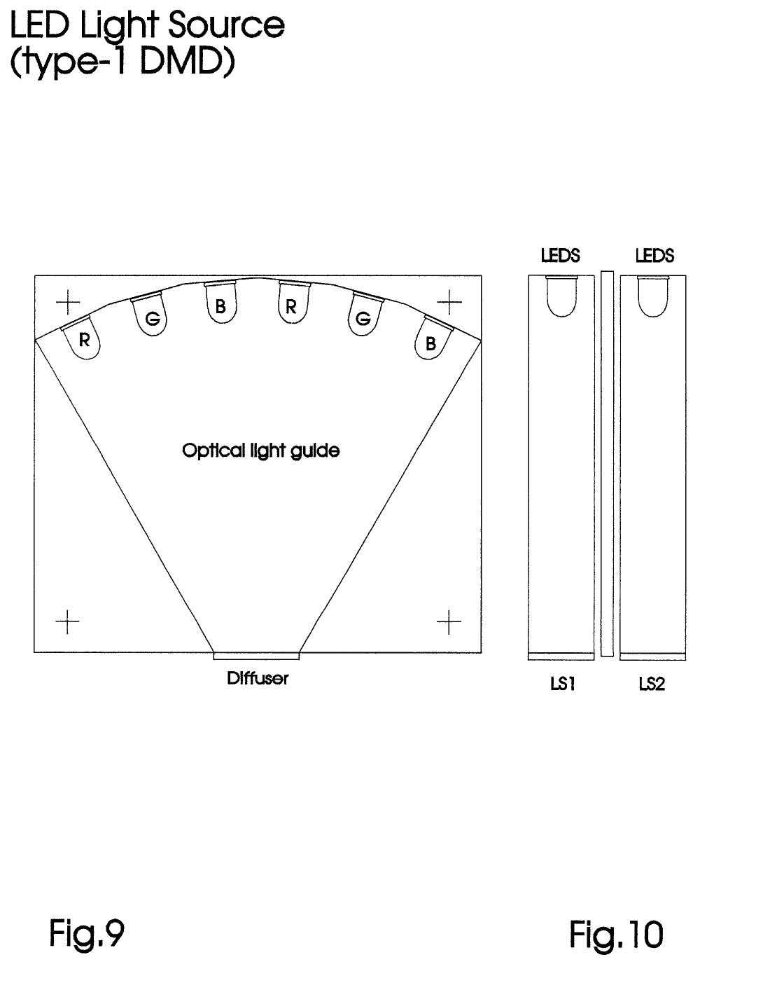

The basic display device used in this design of HMD is a single chip device of reflective design. The basic requirements for this display device are that it is reasonably compact, has a high resolution and has a fast refresh rate. The display device does not produce its own light but instead reflects back light that is incident upon it. At the present time there are two main families of device that fulfill these requirements. The first is the Digital Micro-Mirror array or DMM, more completely described in provisional patent 60/214251. The DMM is a small electronic device containing a large number of tiny mirror elements whose angular orientation can be independently controlled by the delivery of the correct electrical signals. The mirror elements are reasonably good reflectors and as the fill-factor is high, the overall optical efficiency is very good. The response speed of the device is sufficiently fast to allow at least 21 bit color for both eyes at full frame rates. One of the unique characteristics of the DMM device is that by virtue of the mirror elements, light falling directly upon the DMM device will be reflected back from the chip at approximately +−20 degrees from the optical axis of the chip. Because the tiny mirror squares are pivoted at the corners, the plane of reflection falls at an angle of 45 degrees across the surface of the chip. This characteristic is used to advantage by displacing the two light sources above and below the optical axis of the chip at such an angle that this optical deviation occurs in the X-axis only. In order to achieve this result an LED (or other light source) of design such as that shown in FIGS. 9-10 is employed. One advantage of the DMM device is that, because no polarizing is occurring due to the operation of the display chip, if required, conventional polarizing techniques can be used to filter out stray light from one optical path entering into the alternate optical path.

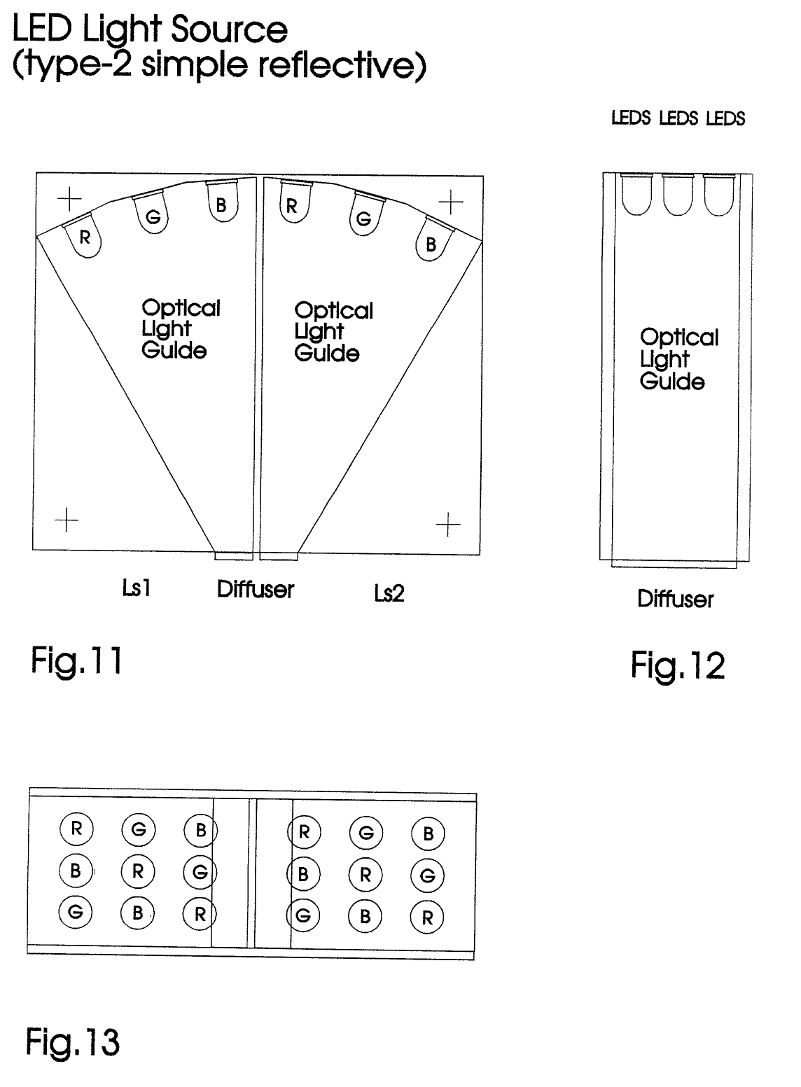

The second type of reflective display device that is currently on the market is that of the Ferro-electric display (FED). This device is of reflective light valve design. The device is similar to a monochrome LCD panel with a reflective mirror surface behind it. As it employs polarizers, the overall optical efficiency will be somewhat lower than that of the DMM device. However, the advantage of this device is that, optically it performs like a simple mirror. As a result the angle of deviation of the light from the surface is due purely to the angle of incidence of the incoming light. Unlike the DMM device, the FED does not rely on angular deviation of the incident light for image generation. As a result, there are little restrictions on the angle of the incident light falling upon the FED. This characteristic ease's the design requirements for the HMD. When used with a simple reflective device such as the FED, the HMD uses a different style of illumination module such as shown in FIGS. 11-13.

Both the DMM device and the FED rely on the display of consecutive red green and blue images to produce a full-color image. In both cases this is possible only because the response speed of the display is very fast which in turn allows fast refresh rates for the display.

The light source shown in detail in FIGS. 9-10 and FIGS. 11-13 could consist of a number of different configurations more completely described in provisional patent 60/214251. The preferred embodiment of this light source is shown in FIGS. 9-10. In this design, the light source consists of a number of red green and blue LED's which are optically coupled to a transparent light-guide. The end of the light-guide may or may not feature a light diffuser of either translucent or scattering design. The object of this diffuser is to make uniform the light emitted from the end of the light-guide. In its simplest form, the light-guide (which will consist probably of plastic or glass may simply have the transmitting end finely textured so as to act as a diffuser. Alternatively, an additional diffuser element may be placed directly in front of the transmitting end of the light-guide to achieve the same result. Although different configurations are possible (and equally valid) the best results have been achieved by making the light-guide semi-circular in design, as shown in FIGS. 9-10 and FIGS. 11-13.

The beam splitter as shown in FIGS. 1-8 is designed to optically combine the two separate light paths for light entering and exiting the DMM device. If the light source is spaced sufficiently from the DMM the beam splitter is not required. However, although technically not essential to the design it has been found that there are significant performance improvements achievable by placing the light source in close proximity to the DMM device. The design of the beam splitter is irrelevant, and although a cube type beam splitter has been shown in the illustrations, any form of beam splitter could be substituted.

As described in the provisional patent 60/214251, if a focusing lens or lens assembly is placed very close to the surface of the RDC, it has little or no effect on the optical characteristics of the display device itself. However, if the light source is placed in the correct position, it will cause the light that reflects from the surface of the RDC to converge to a focus point. This optical arrangement allows the light from the light sources to be effectively brought to focus points at the primary focusing optics, thus effectively fulfilling the DMM's requirement for light control on a pixel by pixel basis (more completely described in patent 60/214251). This optical arrangement has been referred to in this specification as the chip collimating optics (CCO).

The primary focusing optics consist of a lens or group of lenses whose purpose is to produce a real image within the display device for further magnification by the eyepiece optics and consequently to be viewed by the user. The actual design and configuration of the primary focusing optics are not significant in defining the intellectual property covered by this specification and the use of a particular configuration in the illustrations should not be considered a reduction in the generality of the overall design.

The eyepiece optics are designed to form virtual images from the real images I1, I2 that can then be viewed by the user of the HMD. The actual design of the eyepieces used in the HMD are not significant in defining the intellectual property covered by this specification and the use of a particular configuration in the illustrations should not be considered a reduction in the generality of the overall design.

In the case of the DMM design, the pre-focusing optics consist of a lens or group of lenses which are spaced some distance in front of the DMM device such that the distance between the DMM device and the lens or group of lenses is less than the focal distance of that lens or group of lenses. The purpose of this element in the design is to reduce the angular deviation of the light emitted from the DMM device when the micro-mirrors swing between active states. This element is an optional component in the overall design. The advantage of introducing this element is that by reducing the angle of deviation of light from the DMM device, optical errors produced by inaccuracies in the focusing optics can be significantly reduced at the cost of the display being less compact. A beneficial side effect of the use of the pre-focusing optics is that the resultant real images produced are magnified, thus simplifying the eyepiece design.

Wedge prisms can be used to correct the angle of deviation from the DMM device to a more or less parallel optical path. These elements are optional. The decision to use these elements depends largely on the spacing between the optical elements and the quality of the optical elements themselves. The use of primary focusing optics and eyepieces that have good off-axis performance may alleviate the requirement for this component.

The primary mirrors (M1, M2) have significance only in the reflective system. Their role is to fold back the optical paths onto themselves, thus reducing the size of the overall display. It should be noted that the primary focusing optics used in the reflective system consisting of lenses PFO1, PFO2 and plane mirrors M1, M2 could be replaced by concave mirrors provided that such mirrors had good off-axis performance (such as parabolic mirrors). Although not ideal, if the divergence of the optical paths is sufficiently small, spherical mirrors can be successfully employed in the design.

### Straight Through Design

The basic “straight through” design as shown in FIGS. 1-2 consists of a reflective display device (RDC), a beam splitter (BS), two light sources (LS1, LS2), chip collimating optics (CCO), primary focusing optics (PFO1, PFO2) and eyepieces (EP1, EP2).

In this design the focal length of chip collimating optics (CCO) are selected such that the light sources (LS1, LS2) will come to focus points in the optical plane of the primary focusing optics (PFO1, PFO2). These optics in turn produce real images (I1, I2) which are subsequently magnified by eye pieces (EP1, EP2) which produce virtual images that can be viewed by the user of the HMD.

### Reflective System

The basic “reflective system” is in many ways similar to the “straight through” optical design. The main difference is that the primary focusing optics (LS1, LS2) are positioned close to plane mirrors (M1, M2). These mirrors serve to reflect the optical path back through the focusing optics (PFO1, PFO2) to form real images (I1, I2). The main advantage of this system is that it is significantly more compact than the “straight through” design. Additionally the fact that the light passes through focusing optics (PFO1, PFO2) twice means that lenses with a longer focal length can be used (Short focal length lenses are more prone to producing optical distortions).

### Improvements

As can be seen in FIG. 2, the light from the DMM device deviates horizontally into the two optical paths (one for each eye). Although this deviation is necessary to both achieve image generation by the DMM device and to generate the correct inter-ocular spacing (spacing between the eyes of the viewer) the high degree of deviation from the optical axis of the primary focusing optics (+/−14 degrees from center) requires that the optics (PFO1, PFO2) have to be of high-quality (relatively free of spherical aberrations) in order to keep image distortion to a minimum. In addition to distortions introduced by the primary focusing optics, a similar situation exists due to the light passing through the eyepiece optics off-axis. A simple way to eliminate this problem is to straighten the optical path before encountering either the focusing optics or the eyepieces. There are a number of ways in which this can be achieved the easiest of which is to use two opposed prisms (WP1, WP2) to bend the optical path straight prior to the light entering the primary focusing optics. The immediate disadvantage of this approach is that the total path length required to achieve the required inter-ocular spacing will now be at least doubled. It should be noted also that this technique is possible only with the straight through design, because with the mirror design, the reflected light would pass back through the same prism which means that at best, the angle of the incident light could be reduced to half of its original state. In the case of the reflected system, a simpler and less expensive approach is simply to tilt the focusing optics/mirror assemblies inward slightly. The disadvantage of this approach is that in doing so, the primary focusing optics have been pushed out of the object plane. This results in optical distortions which must be dealt with further down the optical path.

An alternative approach is simply not to correct the angle of deviation of the light from the DMM device but simply to reduce the magnitude of that angle. In itself, a slight deviation angle is actually beneficial because it translates into a convergence of the images produced to the viewer. In effect it sets the focal distance (due to optical convergence) at a finite distance in front of the viewer, and given that eye strain will be at a minimum when optical convergence matches the virtual position of the image in space (due to the HMD optics), having a certain degree of optical path deviation is actually beneficial. In its basic form, the DMD produces an angular deviation of +/−14 degrees from center. If this deviation can be reduced to approximately half that value, then it may not be necessary to straighten the optical path at any stage in the design. The main disadvantage in this approach is that it results in a longer optical path than optimal. However, the reduction in optical complexity and costs may outweigh this factor. This reduction in angle can be readily achieved by introducing pre-focusing optics as shown in FIGS. 1-8. In addition to the advantage of reducing the off-axis angle, the pre-focusing optics reduce the required curvature of the primary focusing optics. This has the added advantage that off-axis performance will be improved (because the lenses have a reduced curvature)

The second factor to consider in the overall system is that of the eyepiece design. An effective HMD should have a long eye relief (distance between the viewer's eye and the optics) and a wide “sweet-spot” (region in which a clear image can be seen by the viewer). Ideally, if the “sweet-spot” is sufficiently large, then inter-ocular adjustment will not be required on the HMD. A long eye relief is easily achievable if the magnification factor of the eyepiece is low. In order to achieve the wide viewing angle (an essential factor in a good HMD design) and still have a low magnification factor, the images (I1, I2) must be relatively large. Given that the DMD is a relatively small device (the active area is approximately 15 mm by 11 mm for an 800 by 600 array) some degree of magnification is probably required. This is easily achieved by virtue of the pre-focusing optics (PFO). A wide “sweet spot” requires that the eyepiece lenses be of large diameter.

### Notes

The exact configuration of the light source/beam splitter/display chip device is not significant. Several different configurations are possible, including the light source being directly incident on the display chip and the resultant image being reflected from the hypotenuse of the beam splitter or vice versa. The choice of one configuration over another is arbitrary for the purposes of this specification and should not be considered a reduction in the generality of the overall design.

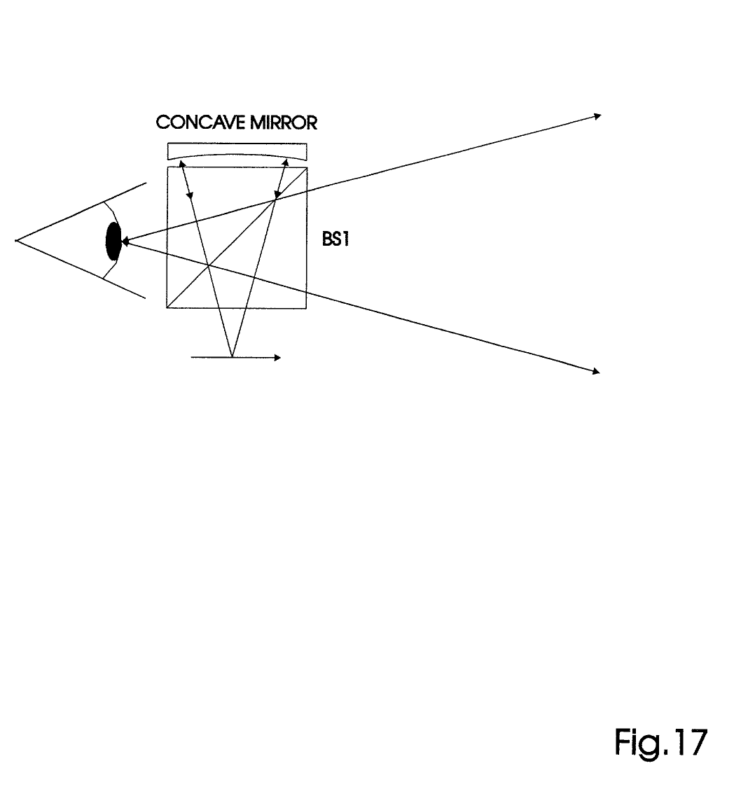

Although eyepiece optics have been shown in the system schematics, these could be replaced by concave mirror/beam splitter arrangements, as shown in FIG. 17. This configuration has the added advantage that it allows the projected images to become a transparent projection over the “real world”. This “see-through” configuration has applications in the field of augmented reality. Equally well, it is also possible to introduce “real world” images into the systems shown in FIGS. 1-8 by using a combination of partially silvered mirrors and lens based correction optics.

If the optical path is appropriately large, it becomes possible to remove the chip collimating optics (CCO) from the design. This is possible because of the large difference in distance between the pre-focusing optics and the light sources vs. that between the pre-focusing optics and the RDC.

It should also be noted that although the system design has been optimized for producing a stereoscopic image (separate view to each eye) this system is also capable of producing a single image by simply removing half of the paired optical components. In certain applications such as for use as a viewfinder in video cameras etc. a monocular design may be preferable.

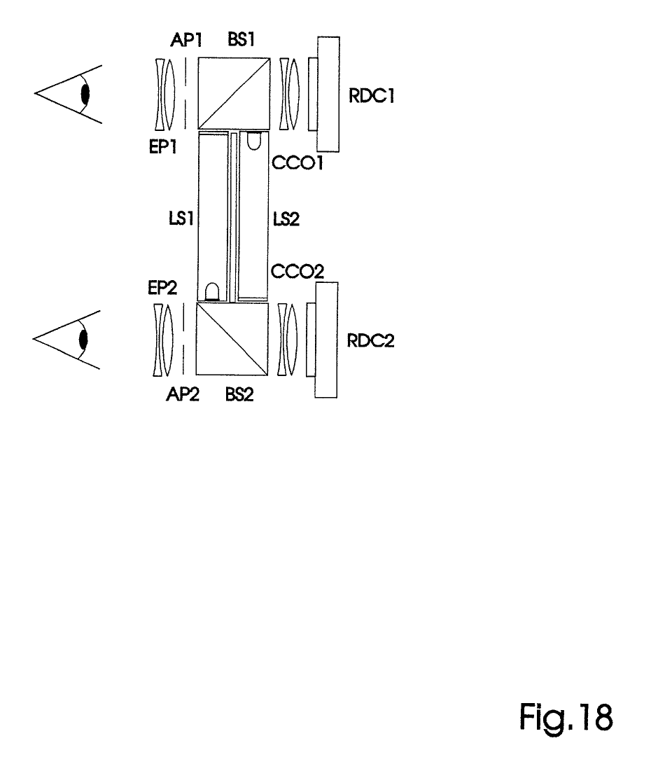

Although the HMD designs illustrated in FIGS. 1-8 have the advantage that a true stereoscopic display is achievable utilizing only a single display chip, if the situation becomes one that the display chip itself is less expensive than the associated optics, then the two chip design shown in FIG. 18 may be more appropriate. This design consists of the same basic optical elements as the “straight through configuration”. As there is no requirement to generate a real image, the pre-focusing optics are not required. Additional elements, aperture 1, aperture 2 (AP1, AP2) are required only if the reflective display chip is of DMD design. The apertures can of course be eliminated from the design by simply utilizing eyepieces with smaller diameter lenses.

Although the DMM device and the FED have been cited as examples in this specification it should be noted that this optical design will work with any reflective type display technology which meets the aforementioned requirements.

1. A compact display device that utilizes a single reflective display device for the generation of either a single or pair of separate images.

2. A helmet mounted display device that utilizes a display element as defined in claim 1 for the generation of its images.

3. A light source that is capable of producing the three optical primary colours (blue, green and red or yellow) and is capable of switching between them rapidly.

4. A light source as described in claim 3 that is comprised of a group of 1 or more light emitting diodes, or other light sources that have both a relatively fast response time and can produce light with colours that are substantially equivalent to the three optical primary colours (blue, green and red or yellow), which are optically coupled to an optical light guide.

5. A light source as described in claim 3 that is comprised of a group of 1 or more light emitting diodes, or other light sources that have both a relatively fast response time and can produce light with colours that are substantially equivalent to the three optical primary colours (blue, green and red or yellow), which are optically coupled to a diffuser by virtue of an optical light guide.

6. An illumination module that consists of two light sources as described in claims 3-5 which are physically displaced laterally.

7. An illumination module that consists of two light sources as described in claims 3-5 which are physically displaced vertically.

8. A display device as described in claim 1 that incorporates a single reflective display device, an illumination module as described in claims 6-7, a beam splitter, a pair of focusing lenses, a pair of plane mirrors and a pair of eyepieces to focus and direct the light to the eyes of the viewer to produce two separate images.

9. A display device as described in claim 8 and illustrated in FIGS. 1-4 that utilizes light sources (LS1, LS2) to direct light onto a reflective display device (RDC). The resultant image from which is directed by a beam splitter (BS) onto a pair of focusing lenses or lens arrays (PFO1, PFO2) the said lens arrays being situated close to and in the same optical plane as a pair of plane mirrors (M1, M2) which reflect the light to a pair of laterally displaced focus points where real images I1, I2 are formed. These images are then viewed via eyepieces (E1, E2).

10. A display device as described in claim 9 that has the reflective display device (RDC) and beam splitter (BS) oriented such that light from light sources (LS1, LS2) is directed by beam splitter BS onto the reflective display device (RDC). The resultant image reflected from the RDC then passes directly through the beam splitter and is incident on a pair of focusing lenses or lens arrays (PFO1, PFO2).

11. A display device as described in claim 1 that incorporates a single reflective display device, an illumination module as described in claims 6-7, a beam splitter, a pair of focusing lenses and a pair of eyepieces to focus and direct the light to the eyes of the viewer to produce two separate images.

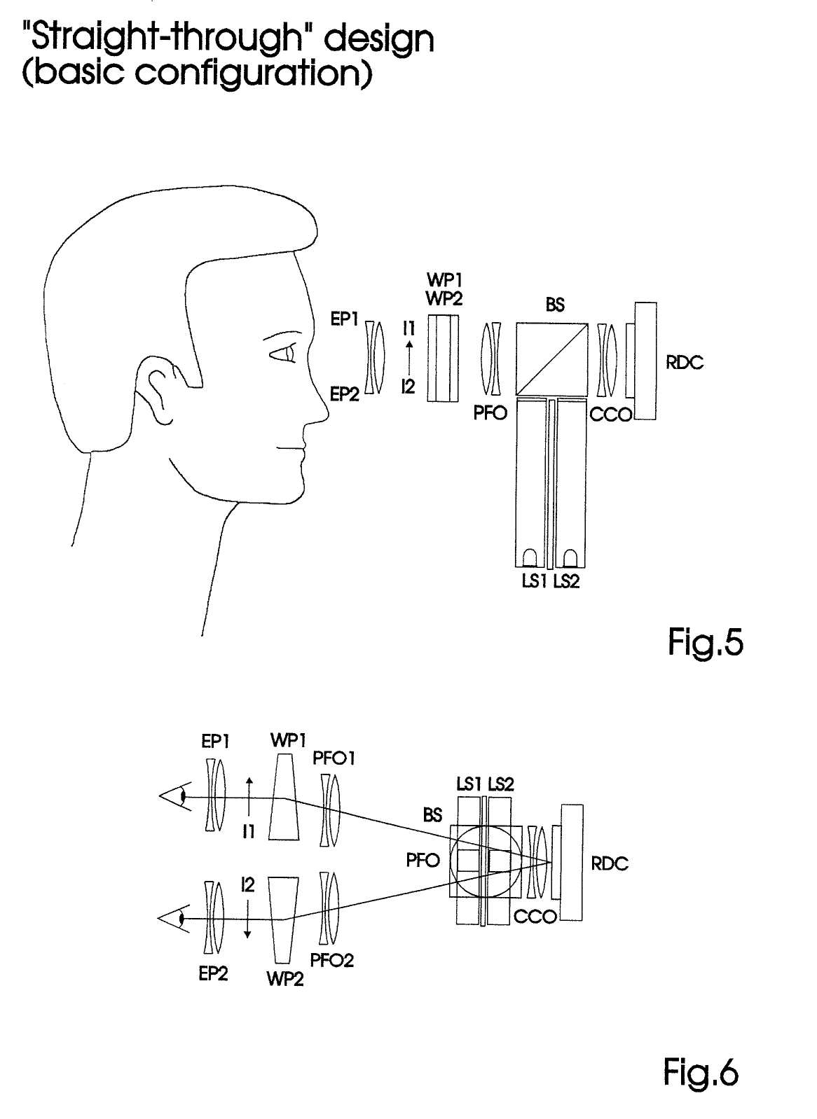

12. A display device as described in claim 11 and illustrated in FIGS. 5-8 that utilizes a beam splitter (BS) to direct light from light sources (LS1, LS2) onto a reflective display device (RDC). The resultant image from which is incident onto a pair of focusing lenses or lens arrays (PFO1, PFO2) which bring the light to a pair of laterally displaced focus points where real images (I1, I2) are formed. These images are then viewed via eyepieces (E1, E2).

13. A display device as described im claim 12 that has the reflective display device (RDC) and beam splitter (BS) oriented such that the incident light from light sources (LS1, LS2) is directly incident onto the RDC and the resultant reflected images from the RDC are reflected by the beam splitter (BS) toward the focusing lenses or lens arrays (PFO1, PFO2).

14. A display device as described in claims 8-10 such that the focusing lenses or lens arrays (PFO1, PFO2) and the plane mirrors (M1, M2) are replaced by a pair of concave mirrors.

15. A display device as described in claims 8-14 and illustrated in FIGS. 1-8 such that a focusing lens or lens array (CCO) is placed in close proximity to and in the same optical plane as the reflective display device (RDC) such that light from the light sources (LS1, LS2) as described in claims 3-5 passes twice through the said focusing lens or lenses.

16. A display device as described in claims 8-15 and illustrated in FIGS. 1-8 such that a pre-focusing lens or lens array (PFO) is placed at some distance from and in the same optical plane as the reflective display device (RDC) such that light reflecting from the said reflective display device is converged to a pair of focus points located at the primary focusing optics (PFO1, PFO2).

17. A display device as described in claims 8-16 and illustrated in FIGS. 1-8 such that a pair of opposed wedge prisms are used to make parallel the two optical paths prior to them entering the eyepiece optics EP1, EP2.

18. A display device as described in claims 8-10, 14-17 and illustrated in FIGS. 1-8 which comprises a mechanical means for adjusting the angular displacement of the primary focusing lens/mirror assemblies in conjunction with an associated adjustment of the lateral spacing between the two eyepieces (EP1, EP2) to achieve inter-ocular adjustment.

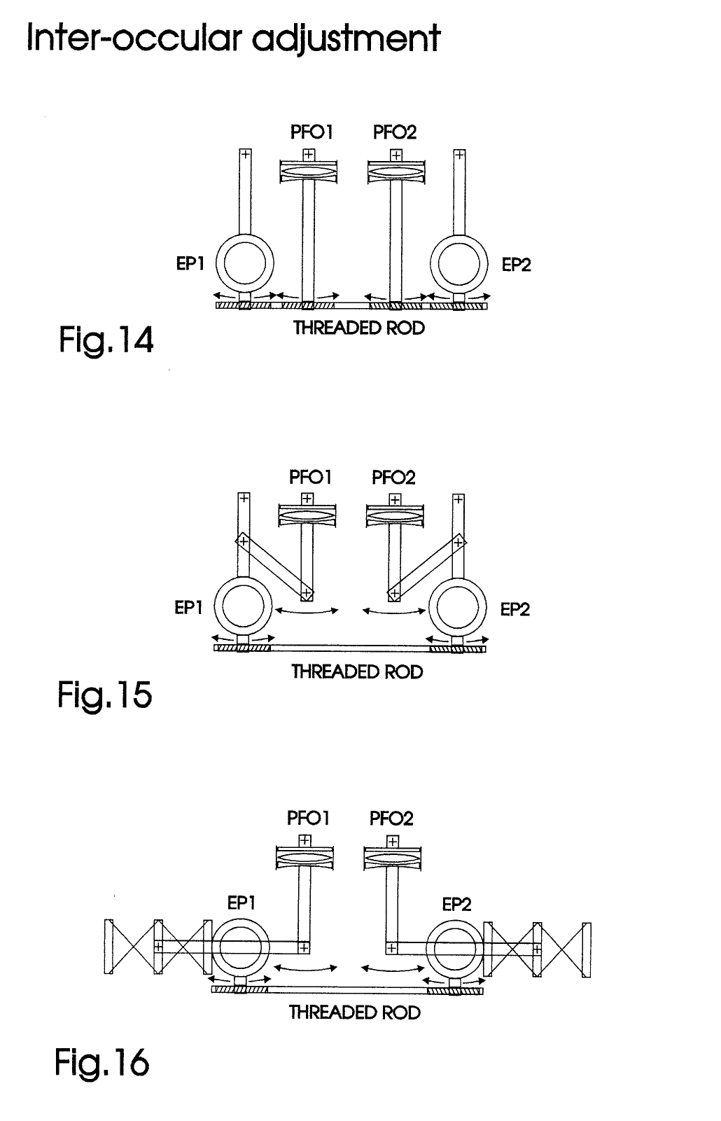

19. A display device as described in claim 18 and illustrated in FIG. 14 such that the relative movement of the lens/mirror assemblies and the eyepieces is governed by a threaded rod drive whereby threads of different pitch (turns per inch) and direction are utilized to maintain the correct relationship of angular adjustment between the lens mirror assemblies and the eyepieces to maintain a continuous optical path between the two.

20. A display device as described in claim 18 and illustrated in FIG. 15 such that the relative movement of the lens/mirror assemblies and the eyepieces is governed by a mechanical linkage whereby the linkage is such that the correct relationship of angular adjustment between the lens mirror assemblies and the eyepieces is maintained to guarantee a continuous optical path between the two.

21. A display device as described in claim 18 and illustrated in FIG. 16 such that the relative movement of the lens/mirror assemblies and the eyepieces is governed by a mechanical linkage to a concertina assembly whereby the linkage is such that the correct relationship of angular adjustment between the lens mirror assemblies and the eyepieces is maintained to guarantee a continuous optical path between the two.

22. A display device that incorporates two reflective display devices, a pair of light source as described in claims 3-5, two beam splitters and a pair of eyepieces to focus and direct the light to the eyes of the viewer to produce two separate images.

23. A display device as described in claim 22 and illustrated in FIGS. 18 that utilizes light sources (LS1, LS2) to direct light onto reflective display devices (RDC1, RDC2). The resultant images from which are directed by a beam splitters (BS1, BS2) onto a pair of rectangular apertures (AP1, AP2) and then on eyepieces E1, E2.

24. A display device as described in claim 23 and illustrated in FIG. 18 that replaces the apertures AP1, AP2 by smaller diameter eyepieces EP1, EP2 to achieve a similar result.

25. A display device as described in claims 8-24 and illustrated in FIG. 17 such that the eyepieces have been replaced by a beam splitter/concave mirror assemblies.

26. A display device as described in claims 11-16 such that employs a pair of opposed wedge prisms (WP1, WP2) positioned such that they intersect the light reflecting from the RDC prior to it entering the primary focusing optics (PFO1, PFO2) thereby making the two optical paths substantially more parallel from this point onwards.
